(19) United States
(12) Patent Application Publication
(10) Pub. No.: US 2026/0350743 A1
(43) Pub. Date: Nov. 5, 2026

(54) FRAME AGGREGATION FOR MULTI-BEAM RASTER SCANNING MICROSCOPES

(71) Applicant: Carl Zeiss MultiSEM GmbH, Oberkochen (DE)

(72) Inventors: Stephan NICKELL, Oberkochen (DE); Tomasz GARBOWSKI, Neresheim (DE); Friedhelm PANTELEIT, Oberkochen (DE)

(21) Appl. No.: 19/712,619

(22) Filed: Jun. 18, 2026

Related U.S. Application Data
(63) Continuation of application No. PCT/EP2024/082829, filed on Nov. 19, 2024.

(30) Foreign Application Priority Data
Dec. 20, 2023 (DE) 10 2023 136 062.0

(51) Int. Cl. G06T 3/4038; G01N 23/2251; G06T 3/4053; G06T 7/00; G06T 7/33

(52) U.S. Cl. CPC G06T 3/4038; G01N 23/2251; G06T 3/4053; G06T 7/0002; G06T 7/337; G01N 2223/401; G06T 2207/10061; G06T 2207/20216; G06T 2207/30168

(57) ABSTRACT

Various examples pertain to frame-aggregation for multiple images multi-beam raster scanning microscopes. Image registration parameters can be assessed and adjusted, if desired. In some embodiments, this can yield better image registration, resulting in a better quality of the overall composite image.

### CROSS-REFERENCE TO RELATED APPLICATIONS

The present application is a continuation of, and claims benefit under 35 USC 120 to, international application No. PCT/EP2024/082829, filed Nov. 19, 2024, which claims benefit under 35 USC 119 of German Application No. 10 2023 136 062.0, filed Dec. 20, 2023. The entire disclosure of each of these applications is incorporated by reference herein

### FIELD

Various examples of the disclosure generally pertain to control and operation of multi-beam raster scanning charged-particle microscopes. For example, various examples pertain to frame averaging or super resolution reconstruction.

### BACKGROUND

In scanning electron microscopes (SEMs) or other types of charged-particle raster scanning microscopes (e.g., helium ion microscopes), the imaging time is often largely defined by the time it takes to scan the sample with the electron beam. To increase the signal-to-noise ratio (SNR), it is possible to increase the so-called dwell time—the time spent by the particle beam in one pixel. Larger dwell times can lead to larger imaging times and improved SNR.

On the other hand, various instabilities inside the SEM can lead to the so-called “drift”—a gradual shift of the field of view (FOV) of the particle beam relative to the imaging object/sample. Underlying causes for drift can include thermal drift, charging, stage instabilities, sample instabilities, or beam instabilities. The drift can lead to a distortion of the acquired image usually observed as “skewing” or “shear” along X- or Y-direction with an amplitude proportional to the imaging time. This is illustrated in FIG. 1. FIG. 1 illustrates an image 2020 acquired using an SEM with a relatively long dwell time, e.g., one microsecond (μs) or longer for a 1×1 nanometer (nm) pixel. In FIG. 1 the distortions are visible. Depicted are semiconductor structures that include straight lines and circular structures arranged in a square pattern. The straight lines are bent and the square pattern is skewed. Circular structures are skewed and appear elliptical.

Techniques are known to mitigate such drift-driven distortions. One approach is so-called frame averaging or drift-corrected frame integration. When applying frame averaging—as illustrated in FIG. 2—instead of acquiring a single image taken with long dwell time (as in FIG. 1) and having high SNR but also large distortions, a sequence of “fast” images (or frames) 2001, 2002, 2003, 2004 with low-SNR and low distortions is acquired at a relatively short dwell time. These images 2001, 2002, 2003, 2004 are then combined (typically a pixel-wise summation), at 2000. This yields an aggregate image 2011.

A challenge of frame averaging can be the relative displacement or distortion of the FOVs in the images due to the aforementioned drift. To try to mitigate this, the images 2001, 2002, 2003, 2004 are registered with each other prior to aggregating them. Since the images 2001, 2002, 2003, 2004 have low SNR, the computation of their mutual shift can have limited accuracy, potentially leading to imperfect alignment. As a result, the aggregate image 2011 appears “blurred”, i.e., has reduced resolution.

Recently, multi-beam SEMs (MSEMs) have been employed to provide large-scale composite images of samples. Here, multiple sequences of images are acquired contemporaneously for multiple FOVs that arranged in a spatial pattern, to thereby define a composite FOV. The images of each sequence are combined, using frame averaging. The respective aggregate images thereby obtained are stitched to form a composite image.

It has been observed that challenges that exist for frame averaging for single-beam SEMs can multiply for frame averaging employed for MSEMs. Distortions and/or blur can cause artifacts when stitching to form the composite image. The stitching can become less accurate or artifacts can form at the borders of adjacent FOVs.

### SUMMARY

It is desirable to provide advanced techniques of obtaining a composite image for a composite FOV provided by multi-beam particle raster scanning microscopes such as an MSEMs.

In an aspect, the disclosure provides a method of using a processing device. The processing device is associated with a multi-beam particle raster scanning microscope. Each of multiple particle beams of the multi-beam particle raster scanning microscope defines a field of view. The multiple fields of view of the multiple particle beams are arranged in a spatial pattern and thereby define a composite field of view. The method includes controlling the multi-beam particle raster scanning microscope to contemporaneously acquire sequences of respective images for each field of view. The method also includes, for at least some of the images, determining respective image registration parameter values. The method further includes adjusting one or more of the image registration parameter values based on a comparison of the image registration parameter values. The method further comprises for each of the multiple fields of view: based on the respective image registration parameter values, aggregating the respective images of the respective sequence, to obtain a respective aggregated image. The method further includes stitching the aggregated images obtained for each of the multiple fields of view in accordance with the spatial pattern, to thereby obtain a composite image for the composite field of view.

In an aspect, the disclosure provides a processing device is disclosed configured to perform a method according to the disclosure.

In an aspect, the disclosure provides a system which includes a processing device according to the disclosure and a multi-beam particle raster scanning microscope.

The comparison of the image registration parameter values may take into account at least one of a spatial neighborhood relationship between the respective fields of view as defined by the spatial pattern, or a temporal neighborhood relationship between the images along the sequences. A large amount of data can be used to detect outliers. This enables to determine outliers or inaccurate image registration parameter values more accurately.

The comparison of the image registration parameter values may be based on a distribution of the image registration parameter values. This can help enable determination of outliers or inaccurate image registration parameter values more accurately.

For example, the distribution is across the image registration parameter values of a subset of all images. By not considering all images, only relevant references for a given image can be considered.

The subset of all images may be selected based on a spatial neighborhood relationship between the respective fields of view as defined by the spatial pattern. Neighboring images may be considered as references. This can help enable determination of outliers or inaccurate image registration parameter values more accurately.

The subset of all images may be selected based on a temporal neighborhood relationship between the images along the sequences. Neighboring images may be considered as references. This can help enable determination of outliers or inaccurate image registration parameter values more accurately.

The method may further include, for each of the multiple fields of view, applying a filter for discarding images in accordance with one or more image quality metrics. Noisy images may be discarded. Charging or blur effects may be detected.

The one or more image quality metrics may take into account a temporal neighborhood relationship between the images along the sequences. Changes in the image quality along time axis can be detected.

The filter may discard images in regimes of the sequence at a beginning or and end of the respective sequence. In general, this is based on the underlying physics of the imaging process. Charging of the sample at the beginning of the image sequence may deteriorate the image quality. Material build-up at the end of the image sequence may deteriorate the image quality.

The image quality metrics may be selected from the group comprising: peak signal to noise, PSNR; structural similarity index, SSIM; Fourier ring correlation, FRC; or spectra signal to noise ratio, SSNR. These image quality metrics enable to reliably detect poor quality images.

Adjusting the image registration parameter values associated with a given one of the multiple images may be based on further image registration parameters values associated with one or more further ones of the multiple images. It is possible to interpolate or extrapolate image registration parameter values from another reference. This can help yield reliable replacements.

The one or more further ones of the multiple images may be selected in accordance with at least one of a spatial neighborhood relationship between the respective fields of view as defined by the spatial pattern, or a temporal neighborhood relationship between the images along the sequences. For instance, neighboring fields of view may be primarily considered, because it can be assumed that they are a good measure for replacements of the image registration parameter values.

The aggregating of the respective images may be based on a super-resolution algorithm. Super-resolution enables to increase the resolution of the images.

This may be based on slight shifts of the pixel positions within each field of view. Intra-field of view super-resolution is possible.

The multiple fields of view may include overlap regions in which two or more of the multiple fields of view overlap. The method may further include, for each of the overlap regions, applying a super-resolution reconstruction based on the respective two or more of the fields of view that overlap in the respective overlap region. This can correspond to intra-field of view super-resolution.

The processing device may include multiple compute units, interconnections between the multiple compute units defining a network topology. The network topology may be configured in accordance with the spatial pattern. This network topology can mimic the spatial pattern. This can help achieve accelerated computation, for example when considering spatial neighborhood criteria.

The processing device may include multiple compute units configured for executing multiple parallel computing threads. The method may further include instantiating multiple parallel computing threads and assigning processing tasks associated with different ones of the fields of view to different ones of the multiple parallel computing threads. This can help reduce computation time.

The method may further include allocating memory of the processing device to the multiple parallel computing threads in accordance with at least one of a spatial neighborhood relationship between the respective fields of view as defined by the spatial pattern or a temporal neighborhood relationship between the images along the sequences. Memory access can be reduced. This can help accelerate computation.

The method may further include storing data associated with processing tasks associated with the multiple fields of view in a file, a file format of the file being defined in accordance with at least one of a spatial neighborhood relationship between the respective fields of view as defined by the spatial pattern, or a temporal neighborhood relationship between the images along the sequences. The file format can then be accessed by an appropriate processing algorithm in a faster manner if compared to reference implementations.

Determining the respective image registration parameter values for the at least some of the images, adjusting the image registration parameter values, and aggregating the respective images for each of the multiple fields of view may executed in an iterative process. Better results for the image quality can thereby be obtained.

The method may further include, while the sequences are being acquired, determining image quality values for the respective images and adjusting one or more imaging parameters used for the acquiring based on the image quality values. Real-time or near-real-time monitoring of image quality can become possible.

It is to be understood that the features mentioned above and those yet to be explained below may be used not only in the respective combinations indicated, but also in other combinations or in isolation without departing from the scope of the disclosure.

### BRIEF DESCRIPTION OF THE DRAWINGS

FIG. 1 schematically illustrates an image according to the prior art acquired using a scanning electron microscope using a relatively long dwell time.

FIG. 2 schematically illustrates frame averaging of multiple images according to the prior art acquired using a scanning electron microscope using a relatively short dwell time.

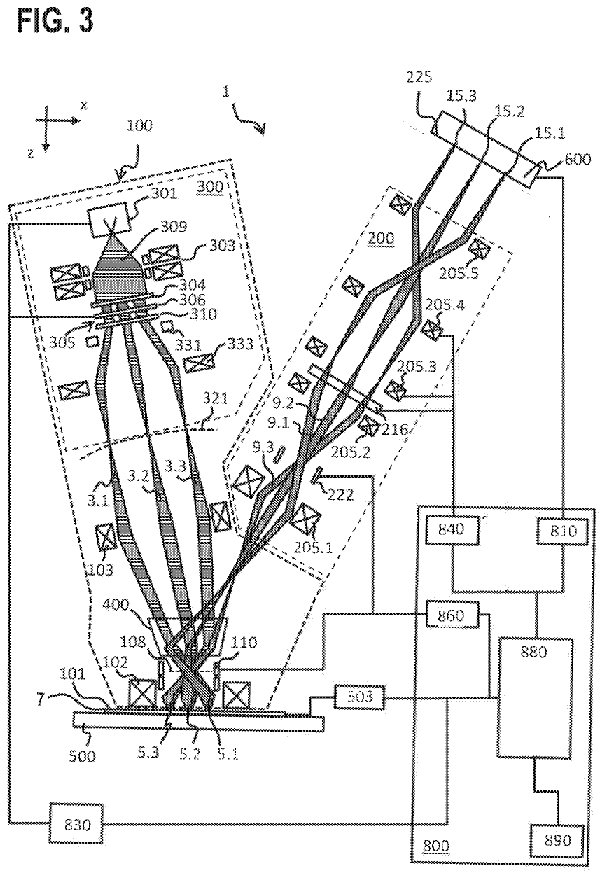

FIG. 3 schematically illustrates an MSEM according to various examples.

FIG. 4 schematically illustrates a spatial pattern of multiple FOVs of an MSEM according to various examples.

FIG. 5 schematically illustrates a spatial pattern of multiple FOVs of an MSEM including overlap regions according to various examples.

FIG. 6 schematically illustrates a sequence of multiple images acquired for a given FOV of an MSEM and further illustrates frame averaging according to various examples.

FIG. 7 is a flowchart of a method according to various examples.

FIG. 8 schematically illustrates image quality values determined for multiple images of a sequence according to various examples.

FIG. 9 is a distribution of image registration parameter values determined for multiple images according to various examples.

FIG. 10 schematically illustrates a processing device including multiple compute units according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the disclosure will be described in detail with reference to the accompanying drawings. It is to be understood that the following description of embodiments is not to be taken in a limiting sense. The scope of the disclosure is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of operating and controlling a multi-beam charged particle raster scanning microscope will be disclosed. For example, techniques will be explained for MSEMs, but other types of multi-beam charged particle raster scanning microscope may be employed as well.

Hereinafter, techniques of frame averaging are disclosed. Here, a sequence of multiple images (also referred to as frames) is acquired and multiple of those images of the sequence are registered and then combined, e.g., averaged. An aggregate image is thereby obtained. The aggregate image has higher SNR if compared to the individual images of the sequence.

For a multi-beam charged particle raster scanning microscope, the multiple sequences are contemporaneously acquired. I.e., multiple charged particle beams are scanned in sync and contemporaneously, yielding multiple images in multiple FOVs. Therefore, the amount of imaging data acquired per time unit is significantly higher if compared to a single-beam charged particle raster scanning microscope. Furthermore, a spatial context and a temporal context is available for each individual image that is acquired. A spatial context is available by comparing images that are acquired contemporaneously (i.e., at the same sequence position) for neighboring FOVs. A temporal context is available by comparing images acquired subsequently for the same FOV (i.e., neighbors within a sequence).

According to various examples, the registration of the images of each sequence takes into account how respective image registration parameter values associated with different images relate to each other. A comparison can be executed that takes into account a spatial neighborhood relationship (defining the spatial context) and/or a temporal neighborhood relationship (defining the temporal context). This enables to detect outliers or unplausible image registration parameter values. Such outliers can be removed or adjusted/corrected.

Alternatively or additionally, the registration can take into account an image quality of each image. Thereby, a more reliable registration of the images of each sequence can be achieved. Outlier registration parameter values can be identified and discarded or corrected. Thereby, the overall quality of the frame averaging and, for example, the image quality of the aggregate images obtained for the multiple sequences of images that are contemporaneously acquired can be increased.

Techniques of determining an image quality value will be disclosed. For example, it has been found that an image quality metric that is based on the Fourier Ring correlation (FRC) can be helpful to reliably assess the quality of each image.

Furthermore, super-resolution reconstruction is disclosed. Super-resolution reconstruction may be based on overlaps in between FOVs of the multibeam charged particle raster scanning microscope are disclosed. Super-resolution reconstruction typically involves an accurate registration of images that overlap with each other. Super-resolution may also be used to aggregate images for each FOV. Due to the increased accuracy of the registration, as explained above, better registration results can be achieved; thereby, the super-resolution reconstruction can also be supported, resulting in an improved quality of the reconstructed images.

According to various examples, imaging data (e.g., including multiple sequences of images/frames) acquired using MSEM is processed. Parallel processing is disclosed. Techniques are disclosed that enable to use a parallel computing hardware such as a Graphics Processing Unit (GPU) or a compute cluster for parallel processing of different parts of the imaging data. A topology (e.g., a hardware-defined topology) of a compute cluster can mimic the spatial neighborhood relationship of the FOVs for which images are processed by each compute unit. For illustration, parts processed in parallel can be formed by images of different sequences or images selected based on a spatial neighborhood relationship and/or a temporal neighborhood relationship. By employing parallel processing, processing of the image data—e.g., for frame averaging or stitching—can be accelerated. Realtime or near-realtime processing becomes possible.

Various aspects are based on the finding that big data analysis techniques can be employed for processing of imaging data acquired using an MSEM. This is because the amount of imaging data acquired per time unit is particularly large. This is because multiple pixels are sampled in parallel. It is possible to leverage spatial neighborhood relationships and/or temporal neighborhood relationships in the big data analysis. The image quality of the overall resulting images can be improved.

Various techniques disclosed herein are based on the finding that in reference implementations the stage or system drift can lead to inferior image resolution and image quality, e.g., reduced SNR, as well as to artifacts. Conventional frame averaging can fail when features/correlations are not available or lead to wrong image registration parameter values. According to the techniques disclosed herein, it is possible to mitigate such restrictions and drawbacks.

Various techniques are further based on the finding that accumulation of imaging electrons can lead to sample charging which then leads to inferior image resolution and image quality, i.e., low SNR as well as to artifacts. In reference implementations, this can often render images meaningless and useless. Frame averaging can then fail. According to the techniques disclosed herein, it is possible to mitigate such restrictions and drawbacks by selecting and averaging only useful images which results in high resolution, artefact free, high SNR images

Furthermore, techniques are based on the finding that the data throughput in reference implementations is relatively slow, e.g., if compared to other microscopy techniques such as light microscopy. Thus, the relatively slow, non-real-time processing of imaging data acquired using MSEM limits their adoption across various use fields, e.g., life science, material science or semiconductor applications. According to the techniques disclosed herein, the data throughput can be increased, enabling fast processing of imaging data. Real-time or near real-time image processing becomes possible.

Still further, the techniques disclosed herein are based on the finding that stitching of multiple images associated with different FOVs of a MSEM often suffers, in reference implementations, from imperfections of the individual images. Thus, also the composite image obtained from stitching can have a limited quality. According to the techniques disclosed herein, it is possible to mitigate such restrictions and drawbacks.

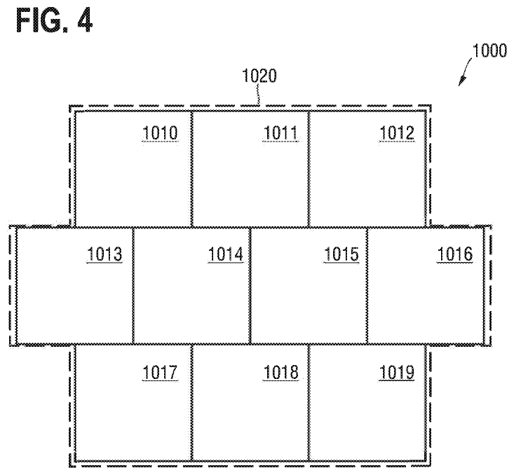

FIG. 3 is a schematic illustration of an MSEM 1. Further information relating to such MSEMs and components used therein, such as, for instance, particle sources, multi-aperture plate and lenses, can be obtained from the international patent applications WO 2005/024881, WO 2007/028595, WO 2007/028596, WO 2011/124352 and WO 2007/060017 and the German patent applications having the publication numbers DE 10 2013 016 113 A1 and DE 10 2013 014 976 A1, the disclosure of which in the full scope thereof is incorporated by reference in the present application.

The MSEM 1 uses a plurality of charged particle beams (also referred to as beamlet) for imaging a sample 7. The MSEM 1 generates a plurality of J primary beamlets 3.1, 3.2, 3.3 which strike the sample 7 to generate interaction products, e.g., secondary electrons, which emanate from the sample 7, form secondary beamlets 9.1, 9.2, 9.3, and are subsequently detected.

Each one of the primary and secondary beamlets 3.1, 3.2, 3.3, 9.1, 9.2, 9.3 is formed and guided by a respective imaging subsystem of the MSEM 1. Each imaging subsystem is associated with a respective FOV. Images acquired by a respective imaging subsystem depict the respective FOV. The multiple FOVs are arranged in a spatial pattern to thereby define a composite FOV.

The primary beamlets 3.1, 3.2, 3.3 are formed by electrons which are incident on a surface of the sample 7 at a plurality of locations and generate a plurality of primary electron beam focus spots 5,1 5.2, 5.3 that are spatially separated from one another.

The sample 7 to be examined can be of any desired type, e.g., a semiconductor wafer or a semiconductor mask, and can comprise an arrangement of miniaturized elements.

The surface of the sample 7 is arranged in a sample plane 101 of an objective lens system 102 of a first particle optical unit 100 (also referred to as illumination system).

A diameter of the minimal beam spots or focus spots 5,1 5.2, 5.3 shaped in the sample plane 101 can be small. Exemplary values of this diameter are below four nanometers, for example three nm or less. The focusing of the primary beamlets 3.1, 3.2, 3.3 for shaping the focus spots 5,1 5.2, 5.3 is carried out by the objective lens system 102. In this case, the objective lens system 102 can comprise a magnetic immersion lens. Further examples of focusing mechanisms are described in the German patent DE 102020125534 B3, the entire content of which is herewith incorporated in the disclosure.

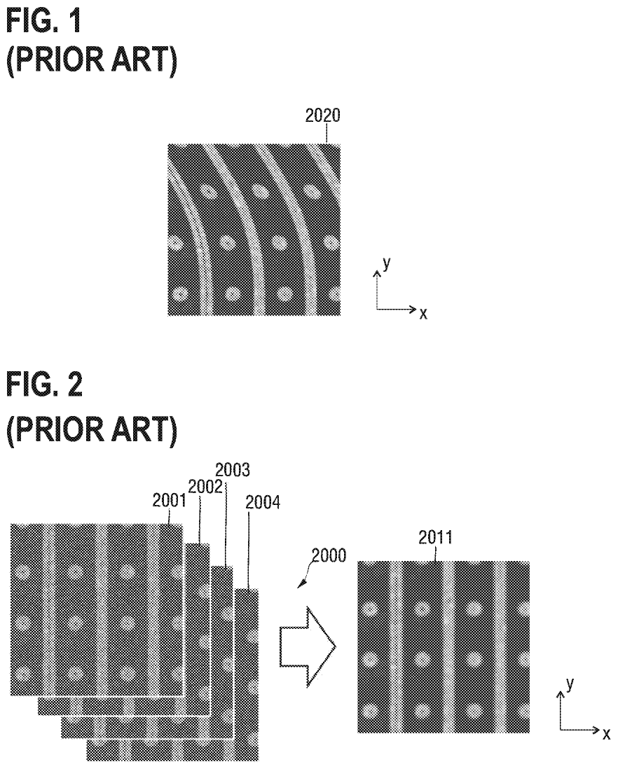

The number J of primary beamlets 3.1, 3.2 and 3.3 (i.e., the number of FOVs) may be five, 25, 90 to 100, or more (for sake of simplicity, only three primary beamlets 3.1, 3.2 and 3.3 with corresponding focus points 5.1, 5.2 and 5.3 are shown in FIG. 1).

In practice, the number of beamlets J, and hence the number of FOVs, can be chosen to be significantly greater, such as, for example, J=10×10, J=20×30 or J=100×100. Exemplary values of the pitch between the incidence locations and FOVs are 1 micrometer, 10 micrometers, or more, for example 40 micrometers.

The number of primary and secondary beamlets J defines the number of FOVs. Each imaging subsystem has a respective FOV. The respective FOV is defined by scanning the respective pair of primary and secondary beamlets (e.g., beamlets 3.1 and 9.1) over the sample 7 in the respective FOV.

The primary beamlets 3.1, 3.2, 3.3 striking the sample 7 generate interaction products, e.g., secondary electrons, back-scattered electrons, which emanate from the surface of the sample 7, or primary particles that have experienced a reversal of movement for other reasons. The interaction products emanating from the surface of the sample 7 are shaped by the objective lens system 102 to form the secondary beamlets 9.1, 9.2, 9.3. Secondary electrons included in the secondary beamlets 9.1, 9.2, 9.3 are used for imaging.

The MSEM 1 provides a detection beam path for guiding the plurality of secondary beamlets 9.1, 9.2, 9.3 to a secondary electron imaging system 200. The secondary electron imaging system 200 includes several electron-optical lenses 205.1 to 205.5 for directing the secondary beamlets 9.1, 9.2, 9.3 towards a spatially resolving detector system 600.

The imaging with the secondary electron imaging system 200 is strongly magnifying such that both the pattern of the primary beamlets on the wafer surface and the size and shape of focal points of the primary beamlets are imaged in much magnified fashion. By way of example, a scale factor/magnification is between 100× and 300× such that one nm on the wafer surface is imaged enlarged to between 100 nm and 300 nm. In an example, an image field of a multi-beam device with for example 100 μm diameter is enlarged to approximately 30 mm.

The primary beamlets 3.1, 3.2, 3.3 are generated in a beam generation apparatus 300 comprising at least one particle source 301 (e.g., an electron source), at least one collimation lens 303, a multi-aperture arrangement 305 and a first field lens 331 and a second field lens 333. The particle source 301 generates at least one diverging particle beam 309, which is at least substantially collimated by the at least one collimation lens 303, and which illuminates the multi-aperture arrangement 305. The multi-aperture arrangement 305 includes an aperture plate 304 (also referred to as filter plate or multi-hole aperture plate), which has a plurality of J openings formed therein in a first raster arrangement. Particles of the illuminating particle beam 309 pass through the J apertures or openings of the first aperture plate 304 and form the plurality J of primary beamlets 3.1, 3.2, 3.3. Particles of the illuminating particle beam 309 which strike the first aperture plate 304 are absorbed by the latter and do not contribute to the formation of the primary beamlets 3.1, 3.2, 3.3. A multi-aperture arrangement 305 usually has at least a further multi-aperture plate 306, for example a lens array, a stigmator array, or an array of deflection elements.

Together with the field lens 331 and a second field lens 333, the multi-aperture arrangement 305 focuses each of the primary beamlets 3.1, 3.2, 3.3 in such a way that focal points are formed in an intermediate image surface 321. Alternatively, the beam foci and the intermediate image surface 321 can be virtual. The intermediate image surface 321 can be curved to pre-compensate a field curvature of the imaging system arranged downstream of the intermediate image surface 321.

The at least one field lens 103 and the objective lens system 102 provide a first imaging particle optical unit for imaging the surface 321, in which the beam foci are formed, onto the sample plane 101 such that a second pattern of focus spots 5,1 5.2, 5.3 of the primary beamlets 3.1, 3.2, 3.3 is formed there. Typically, the surface 25 of the sample 7 is arranged in the sample plane 101, and the focal spots 5,1 5.2, 5.3 are correspondingly formed on the object surface 25. The plurality of primary beamlets 3.1, 3.2, 3.3 form a crossover point 108, in the vicinity of which a first deflection scanner 110 is arranged. The first deflection scanner 110 is used to deflect the plurality of primary beamlets 3.1, 3.2, 3.3 collectively and synchronously such that the plurality of focus spots 5,1 5.2, 5.3 are moved contemporaneously over the surface 25 of the sample 7. Raster scanning is implemented, thereby imaging the sample 7. The first deflection scanner 110 is driven by a scanning control unit 860 such that in an inspection mode of operation, a plurality of two-dimensional image data of the surface is acquired. Additionally, the MSEM 1 can include further static deflectors configured to adjust the position of the plurality of the primary beamlets 3.1, 3.2, 3.3.

The objective lens system 102 and the projection lenses 205 provide a secondary electron imaging system 200 for imaging the sample plane 101 onto an imaging plane 225. The objective lens system 102 is thus a lens or a lens system that is part of both the first and the second particle optical unit, while the field lenses 103, 331 and 333 belong only to the first particle optical unit 100, and the projection lenses 205 belongs only to the secondary electron imaging system 200.

A beam divider 400 is arranged in the beam path of the first particle optical unit 100 between the field lens 103 and the objective lens system 102. The beam divider 400 is also part of the second optical unit in the beam path between the objective lens system 102 and the projection lenses 205.

The first deflection scanner 110 is arranged in a primary electron beam path or in a joint electron beam path. In the example shown in FIG. 1, the secondary beamlets 9.1, 9.2, 9.3 transmit during use the first deflection scanner 110 in opposite direction and the scanning movement of the secondary beamlets 9.1, 9.2, 9.3 is partially compensated. The secondary electrons have typically a different kinetic energy compared to the primary electrons. Therefore, the scanning movement of the moving irradiation positions is only partially compensated. To fully compensate the scanning movement of the secondary beamlets 9.1, 9.2, 9.3, the collective beam deflector 222 is arranged in the secondary electron beam path.

The secondary electron imaging system 200 includes the second, collective beam deflector 222 which is arranged in the vicinity of a crossover point of the secondary beamlets 9.1, 9.2, 9.3. The second, collective beam deflector 222 is operated synchronously with the first deflection scanner 110 and compensates during use a beam deflection of the secondary beamlets 9.1, 9.2, 9.3 such that centers 15 of the beamlets 9 remain at constant position on the imaging plane 225. Thereby, each secondary beamlet 9 is kept within the area of a set of detection elements, which is assigned to the individual secondary beamlet 9.

The secondary electron imaging system 200 includes electron-optical lenses 205.1 to 205.5 to adjust a focus plane of the secondary beamlets 9.1, 9.2, 9.3. A defocus can be applied. The electron-optical lenses 205.1 to 205.5 can thus implement corrective elements to correct the focus plane. The electron-optical lenses 205.1 to 205.5 are shown as magneto-optical elements but are not limited to magneto-optical elements and can comprise also electro-static lens elements or stigmators. With the electron-optical lenses 205.1 to 205.5, the secondary beamlets 9.1, 9.2, 9.3 can be focused into the imaging plane 225 of the secondary electron imaging system 200.

The secondary electron imaging system 200 can include a plurality of further corrective elements, for example at least one of a multi-aperture array element, a deflector or an exchangeable aperture stop. Together with the objective lens system 102, the lenses serve to focus the secondary beamlets 9.1, 9.2, 9.3 on the spatially resolving detector system 600 and, in the process, allow to correct or compensate the magnification and rotation of the pattern of the secondary beamlets 9.1, 9.2, 9.3 in the imaging plane 225. Thereby, the pattern of the plurality of secondary beamlets 9.1, 9.2, 9.3 can stabilized. For example, a first and second magnetic lenses 205.4 and 205.5 (as further examples of corrective elements) are designed in reversed order to one another and have oppositely directed magnetic fields. A Larmor rotation of the secondary beamlets 9.1, 9.2, 9.3 can be compensated by suitably applying control signals to (driving) the magnetic lenses 205.4 and 205.5. The secondary electron imaging system 200—in the illustrated example—includes further corrective elements, such as a multi-aperture plate 216.

The MSEM 1 furthermore is associated with a processing device 800 configured both for controlling the individual particle optical components of the multiple particle beam system and for evaluating and analyzing the signals obtained by the detector system 600. The processing device 800 can be separated from the MSEM 1 or can be part of the MSEM 1. For example, the processing device 800 can be configured to acquire pairs of test images and then evaluate the test images to determine values of one or more imaging parameters. In this case, the control or processing device 800 can be constructed from a plurality of individual electronic computers or electronic components. By way of example, the processing device 800 includes a control processor 880, a control module 840 for the control of the electro-optical elements of the secondary electron imaging system 200, and a control module 830 for the control of the electro-optical elements of the primary beamlet generation unit. The processing device 800 is further connected to a control module 503 for supplying a voltage to the sample 7, the voltage also being referred to as extraction voltage. Thereby, during use, an extraction field is generated between the objective lens system 102 and the surface 25 of the sample 7. During use, the extraction field decelerates the primary charged particles of the primary beamlets 3.1, 3.2, 3.3 before the object surface 25 is reached and generates an additional focusing effect on the plurality of primary beamlets 3.1, 3.2, 3.3. At the same time, the extraction field serves during use to accelerate the secondary particles out of the surface 25 of the sample 7.

Further, the processing device 800 includes the scanning control unit 860 for the raster scanning.

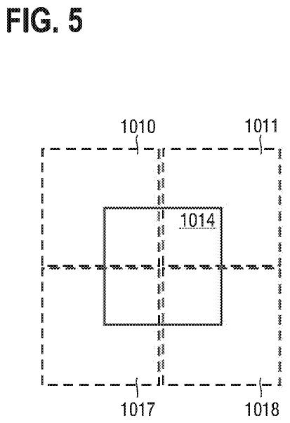

The detector system 600 includes a plurality of sets of detection elements with one set of detection elements for each secondary beamlet 9. During use, each set of detection elements is configured to record the intensity signal of the assigned secondary beamlet 9. The plurality of intensity signals for the plurality of secondary beamlets 9.1, 9.2, 9.3 is transferred to the image data acquisition unit 810, where the image data is processed and stored in memory 890. Accordingly, multiple images are acquired, one for each imaging subsystem. These multiple images (or an aggregated image determined based on images of respective sequences) can be combined to a composite image having a composite FOV. This is shown in FIG. 4.

FIG. 4 schematically illustrates a spatial pattern 1000 of multiple FOVs 1010-1019 associated with the beamlets/particle beams of the MSEM 1. Also illustrated is the associated composite FOV 1020 that is obtained by stitching respective images associated with each of the multiple FOVs 1010-1019.

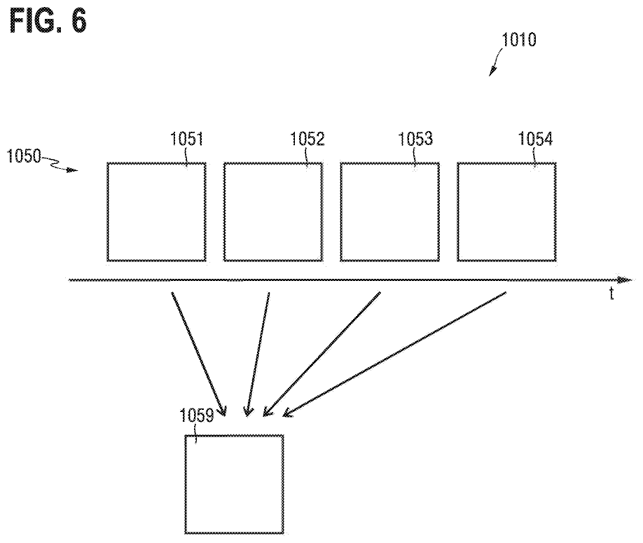

In the scenario of FIG. 4, the spatial pattern 1000 of the FOVs 1010-1019 does not include overlap regions in which two or more of the multiple FOVs 1010-1019 overlap. However, it is generally possible that the spatial pattern 1000 includes overlap regions; this is illustrated in FIG. 5 for the FOV 1014 that overlaps with its neighboring FOVs 1010, 1011, 1017, 1018.

In the scenario of FIG. 5, the overlap degree is 100%; i.e., each part of the sample is scanned twice. Also, larger or smaller overlap degrees would be possible.

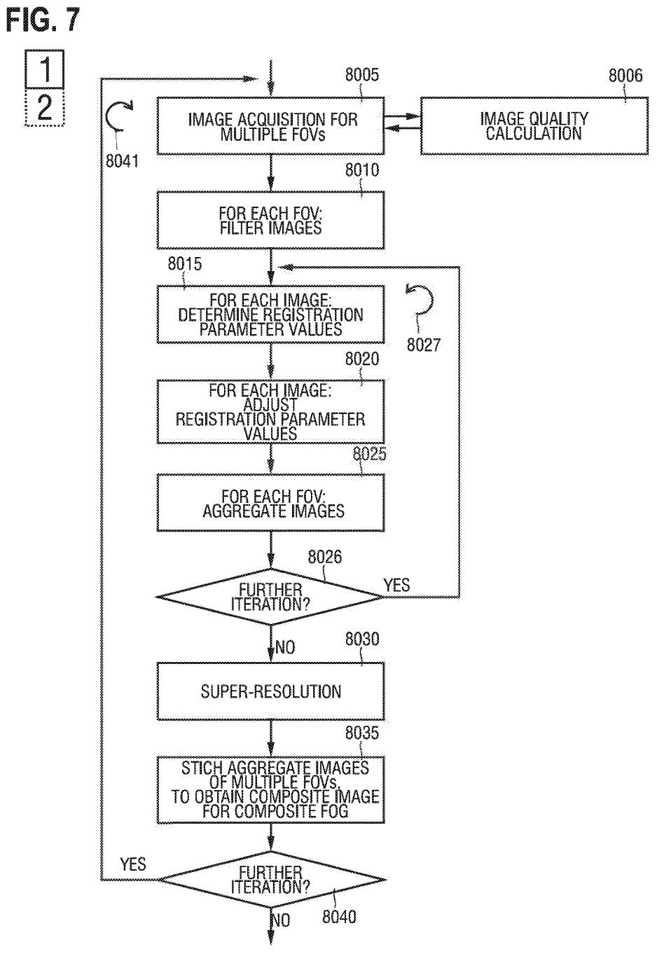

FIG. 6 illustrates aspects of frame averaging. FIG. 6 illustrates—for the example FOV 1010 (all other FOVs can be treated similarly)—that a sequence 1050 of multiple images 1051, 1052, 1053, 1054 is acquired. A relatively short dwell time is used, e.g., shorter than 1 μs.

It is then possible to aggregate the images, e.g., by a pixel-wise summation. To accommodate for shifts of the underlying FOVs—e.g., due to drifts, charging of the sample, etc.—it is possible to determine image registration parameters based on a registration of the images 1051-1054 and take into account the image registration parameters when aggregating.

It is, in general, not required that all images of a given sequence acquired for a respective FOV are taken into account in such an aggregation. Different images can be taken into account at different emphasis levels. Some images may not be taken into account at all, i.e., discarded prior to performing the aggregation. I.e., a filtering can be employed.

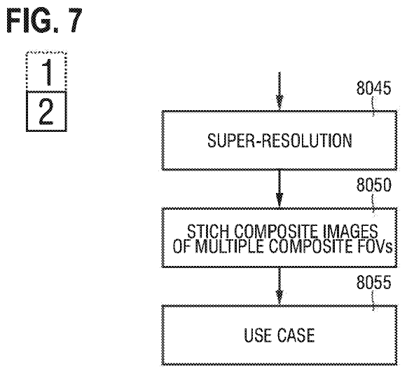

FIG. 7 is a flowchart of a method according to various examples. The method of FIG. 7 is for use in a processing device associated with an MSEM such as the MSEM 1 illustrated in FIG. 3. For instance, the method of FIG. 7 can be executed by the processing device 800 illustrated in FIG. 3. The method of FIG. 7 can be executed using parallel processing distributed amongst multiple compute units.

At box 8005, image acquisition is performed. Multiple images are acquired for multiple FOVs. Box 8005 can include controlling the MSEM to contemporaneously acquire sequences of respective images for each FOV. Such images can be acquired with relatively short dwell times, e.g., dwell times of less than 1 μs.

An example image sequence 1050 has been previously discussed in connection with FIG. 6.

Box 8005 yields imaging data. The imaging data includes multiple images. The multiple images exhibit a temporal relationship, because they are all acquired contemporaneously in respective sequences. I.e., two images acquired at the same sequence position of their sequences, are contemporaneously acquired. The multiple images also exhibit a spatial relationship, because the FOVs for which the are acquired are arranged in a spatial pattern. Some FOVs are direct neighbors, some are second-nearest neighbors, and so forth.

The imaging data can be stored in a file having a file format that is defined in accordance with such spatial neighborhood relationship and/or temporal neighborhood relationship. It is, accordingly, possible to employ a dedicated data format for imaging data including multiple sequences of images for multiple FOVs. Such data format enables the storage and processing of imaging data using the spatial relationship defined by the pattern of FOVs. For instance, header data for each image can be indicative of other images that are adjacent to that image, in spatial domain and/or time domain. Respective pointers may be included. Such file format has the advantage of accelerating subsequent calculations. For instance, some calculations rely on the spatial neighborhood relationship and/or the temporal neighborhood relationship. By structuring the file storing the imaging data, the read requests can be accelerated.

At optional box 8006 it is possible to calculate image quality values for images acquired at box 8005. As illustrated in FIG. 7, box 8006 can be executed in parallel to the execution of box 8005 (albeit it would be possible that box 8006 is executed after completing execution of box 8005).

If box 8006 is executed in parallel to box 8005, the image quality value for a given image acquired at box 8005 is determined before finishing the image acquisition for one or more subsequent images of the same sequence and box 8005. It would then be possible to provide a feedback signal to the image acquisition hardware of the MSEM based on the image quality value, thereby adjusting the imaging process. A feedback loop can be implemented.

Alternatively or additionally, it would also be possible to output a warning or abort the image acquisition process, e.g., if the image quality degrades below a predefined threshold.

Determining the image quality values at box 8006 is based on one more image quality metrics. The image quality metrics may be selected from a group including peak signal to noise, PSNR; structural similarity index, SSIM; Fourier ring correlation, FRC; or spectra signal to noise ratio, SSNR.

For example, PSNR considers a ratio between the maximum possible value (power) of a signal and the power of distorting noise that affects the quality of its representation. Using PSNR as an image quality metric mechanism that the maximum possible value is determined as the maximum pixel value in a first (reference) image; while the power of distorting noise is determined based on a sum of pixel-wise differences of the first image and a second image. In some examples, the first and second images may be neighbors in time domain along the sequence. It would be possible (alternatively or additionally) that the first and second images are spatial neighbors. Also, another reference image can be obtained, e.g., a reference image from frame averaging.

Next, FRC is explained. FRC measures the degree of correlation of the two images over different spatial frequencies. For FRC, a Fourier transformation is applied to each of a pair of images (e.g., two images of the same sequence neighboring in time domain, and/or two images being spatial neighbors acquired at the same time, and/or an image and a reference image). This yields the representation of the images in spatial frequency domain (also referred to as Fourier domain). In spatial frequency domain, the distance of each point of the representation of the images to the center corresponds to the respective spatial frequency. Accordingly, it is possible to compare rings (defined by that distance) between the two representations. Thereby, the intensity of each spatial frequency is compared between the two images.

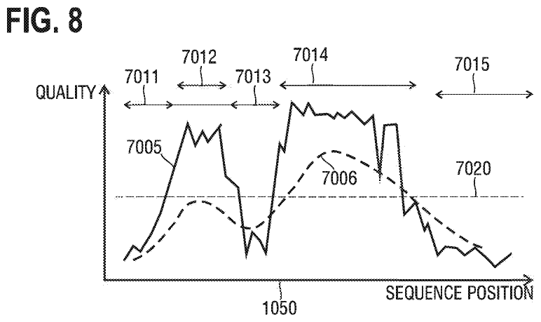

Based on such FRC calculation, it is possible to estimate the resolution of the imaging system. Thereby, the point spread function (PSF) can be determined. For example, it is possible to determine the maximum spatial frequency transferred by the imaging system based on the FRC calculation; and use this as an upper threshold when determining the PSF. This enables a more robust determination of the PSF. This is because information outside of the actual optical resolution is not used. According to examples, the image quality metric can take into account a temporal neighborhood relationship between the images along the sequence. In other words, the image quality metric may not only determine an individual quality value for each individual image; but, additionally, take into account properties of one or more images (or for example their respective individual quality values) arranged adjacent along the sequence of images. A respective example is illustrated in connection with FIG. 8.

FIG. 8 schematically illustrates an example quality value 7005—e.g., FRC—determined individually for each image along the sequence of a given FOV (e.g., by correlating pairs of images that are direct neighbors in time domain or by correlating images acquired contemporaneously and being direct neighbors in spatial domain). As will be appreciated from FIG. 8, there are multiple regimes 7011-7015.

In the regime 7011 the quality value 7005 is relatively low (i.e., the images of the sequence constituting the regime 7011 have a poor quality). During the regime 7012 the quality value 7005 exceeds a certain predefined threshold 7020. The regime 7012 is characterized by a low quality value 7005, i.e., below the threshold 7020. In the following regime 7013, the quality value 7005 again drops below the threshold 7020; to then recover, in the regime 7014, to a high number, corresponding to a good image quality. The regime 7014 is relatively long. Finally, the quality value 7005 degrades permanently, in the regime 7015.

The poor image quality in the regime 7011 may be caused by initial charging of the sample. The poor image quality in the regime 7015 may be caused by a permanent degradation of the sample, e.g., due to deposition of material. The poor image quality in the regime 7013 could be caused by external influences such as shock or vibration.

Next, it is explained how the temporal neighborhood relationship can be taken into account. For example, the image quality metric may take into account a certain temporal hysteresis/latency with respect to the development of the image quality value 7005. The image quality metric may take into account the image quality value 7005 of multiple images that are adjacent, in time domain, along the sequence. A moving average may be calculated (this corresponds to a low-pass filter). The moving average 7006 is also shown in FIG. 8 (dashed line). As a result, based on the moving average 7006 (constituting the final image quality value provided by the image quality metric in the illustrated case), all images in regimes 7011, 7013, 7015 are labeled as having a poor quality i.e., for example at the end of the sequence (where charging of the sample is significant; and at the end of the sequence, when material is being deposited); but also for regime 7012, because it is relatively short, i.e., does not reach stable image quality values above the threshold 7020 for a sufficient count of images. However, this is only one example how to take into account a temporal neighborhood relationship and various other scenarios are conceivable.

Above, a scenario has been disclosed which is based on a temporal neighborhood relationship taken into account by the image quality metric. Alternatively or additionally to such temporal neighborhood relationship, it would also be possible to take into account a spatial neighborhood relationship. For instance, averages between individual image quality values—e.g., FRC—calculated for multiple images contemporaneously acquired and neighboring in spatial domain could be determined.

Next, at optional box 8010 it is possible to apply a filter for discarding images in each of the sequences acquired at box 8005.

Box 8010 can include detecting outliers based on one or more image quality metrics. For instance, certain images can be removed/discarded that show artifacts such as significant drift, charging, defocus jumps, technical errors, environmental effects such as vibration.

For example, it would be possible that the image quality values previously determined at box 8006 are taken into account. For instance, FRC values can be considered (e.g., low-pass filtered or averaged in spatial domain and/or time domain, as previously explained).

For instance, the image quality values can be compared against a threshold and all such images having image quality values below the threshold can be discarded.

Such techniques have been explained in connection with FIG. 8, i.e., the individual image quality values 7005 or the moving averages 7006.

It would be possible to evaluate the image quality values statistically. A distribution of the image quality values can be considered. For instance, a mean value or a standard deviation may be considered. Thereby, statistical outliers can be detected and the associated image can be discarded (i.e., deleted or at least removed from the further processing pipeline).

By (pre-)filtering the images prior to determining a registration amongst the remaining images (as will be explained next in connection with box 8015), it is possible to increase the overall quality of the image registration parameters values.

At box 8015, registration parameter values of image registration parameters of an image registration are determined for the images of each sequence (images discarded at box 8010 are not considered). This may be part of an iterative process; the iterations 8027 are shown in FIG. 7.

Accordingly, in box 8015, for each of the FOVs, respective images are compared with each other to determine the image registration parameters. Image registration parameters are determined based on registrations of those images that are associated with the same FOV.

For instance, values of image registration parameters of a rigid transformation (limited to rotation and translation) can be determined. Another option would be determining values for image registration parameters of an affine transformation, including rotation, translation, scaling, and shearing. Other options are similarity transformations or elastic transformations.

Sources for differences in between the individual images are manifold and include stage drift which can cause a shift of images in lateral directions as well as in the up-down direction resulting in a defocus of the image. Unstable optics are a further underlying reason for differences in between the images of a sequence. Further causes of differences in the images are beam damage and sample contamination. Charging effects can also cause differences.

In general, the calculation of image registration parameter values can have a spatial resolution that is higher than the physical resolution with which pixels of the images are acquired.

The image registration parameter values can be determined for each image within a sequence with respect to a reference image (e.g., the first or last image of the respective sequence or a reference image from a previous iteration 8027, as will be explained later on in connection with box 8026 in detail).

At box 8020, the image registration parameters determined at box 8015 are adjusted. Such adjustment is based on a comparison of the image registration parameter values. For instance, a comparison can be within each FOV and/or across the multiple FOVs. The comparison identifies which of the image registration parameter values are to be adjusted.

The comparison could be against a fixed reference (e.g., one reference per FOV). The comparison could be against a predefined threshold. For instance, all shifts that are smaller than a certain fixed and predefined threshold could be set to zero. For instance, all rotations that are larger than a certain, fixed predefined threshold could be set to zero or to another value.

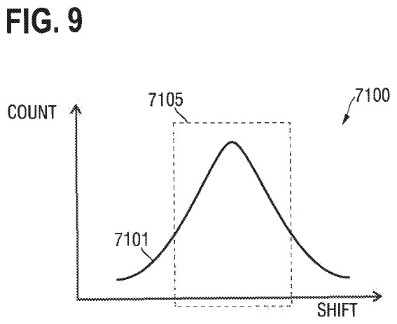

The comparison could also be amongst against other image registration parameter values. A statistical analysis of the image registration parameter values could be executed. For illustration, FIG. 9 shows a distribution 7100 of the image registration parameter value “shift”—quantifying translation, e.g., for a rigid transformation or an affine transformation—across all images taken contemporaneously (i.e., at a given position of the sequence, e.g., in the regime 7014, cf. FIG. 8) for the various FOVs. I.e., the distribution 7100 is across all FOVs. Only a subset of all images is considered, i.e., all images acquired at a specific sequence position. For instance, if 100 images are acquired in all FOVs along respective sequences, the distribution 7100 could be across all 52nd images, to give just one practical example. The standard deviation 7105 is marked.

In general, would be possible to adjust all image registration parameter values outside of the standard deviation 7105 (irrespective of how the distribution is defined). This can be based on the finding that such image registration parameter values are likely to be unreliable, e.g., due to blur or noise in the respective image. Such image registration parameter values likely constitute outliers.

There are various types of distributions that can be considered as part of the comparison.

For example, the distribution can be across all images acquired for a given composite FOV, i.e., across all images of all sequences.

The distribution taken into account for adjusting a given image may be across all images contemporaneously acquired in a certain neighborhood of the given image (i.e., a spatial neighborhood). I.e., a subset of all images can be selected based on the spatial neighborhood relationship of the respective FOVs.

The distribution taken into account for adjusting a given image may be across all images of the respective sequence associated with that FOV. This also corresponds to a subset of all acquired images, here defined by the FOVs.

The distribution taken into account for adjusting a given image may be across all images of the same FOV and neighboring the respective image in time domain (i.e., a temporal neighborhood relationship). A relatively small subset of images is selected.

More generally, a comparison of the image registration parameter values can take a spatial neighborhood relationship and/or a temporal neighborhood relationship between the respective FOVs as defined by the spatial pattern into account.

Once a given set of image registration parameters values of a given image is identified as an outlier based on such comparison, the adjustment can be executed. There are various options available for adjusting image registration parameters values of a given image. For example, it would be possible that image registration parameters values to be adjusted are replaced by other image registration parameters values, e.g., image registration parameters values of another image adjacent in time domain (along the respective sequence of that FOV) and/or image registration parameter values of another image adjacent in spatial domain. Instead of a replacement, also a combination, e.g., a weighted combination could be executed. It would be possible that one or more image registration parameter values of a given image are replaced by the mean or means of the respective distribution used for the comparison explained above.

For example,—referring to FIG. 6—it would be possible that the one or more of the image registration parameter values of the image 1052 (e.g., shift and/or rotation) are considered an outlier. Then, these one or more of the image registration parameter values of the image 1052 can be replaced by or averaged with the respective one or more image registration parameters values of the nearest-neighbor image 1051, or the respective one or more of the image registration parameter values of the nearest-neighbor image 1053, or an average thereof.

In general, the adjusting of given image registration parameter values of a given image can be based on one or more further image registration parameter values selected based on a spatial neighborhood relationship of the FOV of the given image with one or more further FOVs; and/or based on a temporal neighborhood relationship of the image with one or more images along the respective sequence(s).

Now referring back to FIG. 7: upon adjusting the image registration parameters values at box 8020, at box 8025, the respective images of each of the multiple FOVs are aggregated, to obtain a respective aggregate image. A respective aggregate image is obtained for each FOV. Such aggregation can be a pixel-wise averaging or summation; box 8025 may accordingly implement a frame averaging.

Aggregation at box 8025 may also be based on a super-resolution reconstruction. The respective images within each FOV overlap to a large degree, but are slightly shifted with respect to each other. Super-resolution reconstruction generally utilizes minor shifts and/or rotations occurring in between subsequently acquired images. For instance, a certain stage drift of the sample holder/stage of the MSEM is observed in practical scenarios. This is also sometimes referred to as the stage settling process. Details with respect to the super-resolution reconstruction will be explained in connection with box 8030; while box 8030 relates to super-resolution between multiple FOVs, box 8025 may employ super-resolution reconstruction within each FOV. Nonetheless, the super-resolution reconstruction employed at box 8025 may employ the same techniques as explained at box 8030.

The aggregation takes into account the image registration parameters values, i.e., takes into account that there can be image shifts and/or rotations or other transformations in between the images. The respective (inverse) transformation is applied prior to the aggregation, so as to compensate for differences in between the images. Because image registration parameter values that are relatively unreliable or have been identified as outliers have been adjusted at box 8020, high-quality aggregate images can be obtained at box 8025.

As will be appreciated, box 8015, box 8020, and box 8025 implement frame averaging. In various examples, it is possible to execute multiple iterations 8027 of such frame averaging. A subsequent iteration of the multiple iterations 8027 is based on a result of a preceding iteration of the multiple iterations 8027.

A respective decision box 8026 of such multi-iteration frame averaging process is illustrated in FIG. 7. At box 8026, it can be determined whether a further iteration 8027 of the frame averaging is desirable. If so, then the aggregate images obtained from box 8025 for each FOV are used as a new reference for determining the image registration parameter values at box 8015 of the subsequent frame averaging iteration 8027.

If a further iteration 8027 is not required, then the aggregate images as determined at box 8025 are retained as final results in the method commences at box 8030.

Various decision criteria can be used at box 8026 to determine whether a further iteration 8027 of the iterative frame averaging is desirable. Examples include a counter, e.g., to determine whether a minimum count of frame averaging iterations 8027 have been completed. Furthermore, convergence of the aggregate images determined at subsequent frame averaging iterations 8027 can be considered.

At box 8030, it is optionally possible to apply a super-resolution reconstruction (irrespective of whether a super-resolution reconstruction has been previously employed at box 8025). For example, the spatial pattern of FOVs may define overlap regions, as previously discussed in connection with FIG. 5. Then, it is possible to apply a super-resolution reconstruction for each of the overlap regions, based on the respective two or more FOVs that overlap in the respective overlap region.

Super-resolution reconstruction generally utilizes minor shifts and/or rotations occurring in between subsequently acquired images. For instance, a certain stage drift of the sample holder/stage of the MSEM is observed in practical scenarios. This is also sometimes referred to as the stage settling process.

Super-resolution reconstruction can employ techniques available in the prior art, and the particular reconstruction algorithm employed here is not germane for the functioning of the techniques disclosed. For instance, super-resolution reconstruction can be based on prior knowledge such as the point-spread function of the imaging system, and object transfer function, e.g., derived from sample structure information. Machine-learning techniques can be employed.

Super-resolution reconstruction can include interpolation, i.e., predicting pixel values for non-sampled pixels. Various interpolation methods, such as bicubic or bilinear interpolation, can be used. In the overlapping regions, the information from multiple aggregated images is combined. This may involve averaging the pixel values, using more complex algorithms to choose the best pixel values from the different aggregated images, or employing techniques like adaptive filtering.

Generally, super-resolution reconstruction relies on accurate determination of the image registration parameter values. Based on the techniques executed at box 8020 and optionally at box 8010, the accuracy of the image registration parameter values achievable by the disclosed techniques is higher if compared to reference techniques known in the art. Hence, also the super-resolution reconstruction can achieve better results.

A particular super-resolution reconstruction employs the PSF of the imaging system. The PSF describes how a point appears in an image captured using the imaging system. The super-resolution reconstruction uses a model to describe the relationship between the high-resolution image and the captured low-resolution images (here, the aggregated images obtained from box 8025). This model depends on the PSF. The high-resolution image is then estimated by solving this inverse problem. Methods like Wiener deconvolution, regularized deconvolution, or iterative algorithms (like Expectation-Maximization) are used. These methods aim to reverse the blurring effect represented by the PSF, under the constraints imposed by the noise and the low-resolution nature of the original images. For instance, the PSF can be determined based on a Fourier-domain representation of the images, e.g., as determined as part of the image quality calculation, e.g., FRC calculation (cf. box 8006). An upper threshold of spatial frequencies supported by the imaging system can be obtained from the FRC calculation.

The super-resolution reconstruction enables to lower the physical resolution, i.e., the pixel pitch. This reduces the scan time and thereby reduces charging effects or other drifts. This further increases the overall image quality.

At box 8035, it is then possible to stitch the aggregate images obtained from the previous box or boxes in accordance with the spatial pattern defined by the FOVs. Thereby, a composite image for the composite FOV is obtained.

At box 8040, it is optionally possible to determine whether a further iteration 8041 of the boxes 8005-8035 is to be executed for another composite FOV. Each iteration 8041 can be associated with a respective composite FOV. The composite FOVs can be shifted with respect to each other so that they overlap.

Upon completing all iterations 8041, the method commences at box 8045. At optional box 8045, it is possible to apply a super-resolution reconstruction. This can be based on overlap regions defined by the spatial pattern of the multiple composite FOVs.

As will be appreciated, super-resolution reconstruction is generally possible at two levels: i.e., at the level of individual FOVs at box 8030; and/or the level of composite FOVs at box 8045.

At box 8050, it is then possible to stitch the composite images obtained for the multiple composite FOVs in the multiple iterations 8041, to thereby obtain a second-level composite image.

In general, boxes 8040, 8045, 8050 are optional.

At box 8055, a use case is executed. The use case can include extracting one or more imaging properties from the final composite image. Defects of semiconductor structures can be detected. A semiconductor manufacturing process may be controlled based on such information Objects can be detected and/or localized. The final composite image may be stored and/or output.

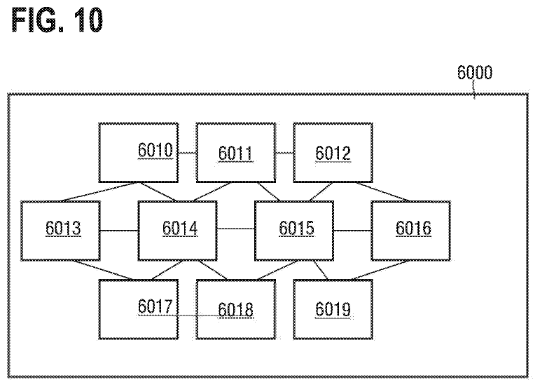

FIG. 10 illustrates aspects in relation to a processing device 6000. The processing device 6000 includes multiple parallel compute units 6010-6019. The processing device 6000 can implement, e.g., the processing device 800 as previously discussed in connection with FIG. 3. The processing device 6000 can be configured for controlling one or more components of an MSEM, e.g., the MSEM 1 previously discussed in connection with FIG. 3.

For example, the processing device 6000 can be a parallel compute cluster with a physical or logical node topology (network topology). This network topology is illustrated in FIG. 10 via the interconnections in between the compute units 6010-6019. Data can be exchanged in-between the various compute units along the interconnections. The interconnections can be hardware-defined.

The different compute units 6010-6019 can be configured for executing multiple parallel computing threads. For instance, it is possible that multiple parallel computing threads are instantiated and assigned with processing tasks associated with different FOVs. For instance, each of the compute units 6010-6019 can be assigned with computing threads executing all processing tasks of a respective FOV. This would enable calculating, in parallel, image quality values and/or image registration parameters for multiple images (cf. box 8015). This leads to reduced image processing time (e.g., for stitching at box 8035) by reducing data transfer time, reducing memory consumption, reducing network overhead time (low latency), and reducing number of compute units. All this leads to a reduced computing time (faster) and lower computing hardware costs.

As described above, for calculation of the image quality values and/or for determining the image registration parameters, comparison amongst respective data of other images can be made. For this, data is exchanged in between the multiple compute units in accordance with a respective spatial neighborhood relationship. To enable this data exchange, the network topology in FIG. 10 is configured in accordance with the spatial pattern 1000 of the FOvs 1010-1019 as previously discussed in FIG. 4. I.e., considering each compute unit 6010-6019 is associated with a respective FOV 1010-1019 (e.g., compute unit 6010 with FOV 1010, compute unit 6011 with FOV 1011, etc.), then interconnections are provided between the compute units 6010-6019 in accordance with the nearest-neighbors of the associated FOVs 1010-1019 in the spatial pattern 1000. This is only one example, it would be possible to provide interconnections for second-nearest neighbors, as well. More generally, the network topology can be configured in accordance with a spatial neighborhood relationship. Thereby, efficient and low-latency data transfer between the compute units 6010-6019 is facilitated.

For instance, the processing device 6000 can be a graphics processing unit (GPU). A GPU contains a plurality of cores designed for parallel processing. These cores are grouped into larger units called compute units (cf. compute units 6010-6019). Each compute unit can execute a different set of instructions independently and simultaneously. Inside each compute unit, the cores handle multiple threads of execution. These sets of threads can be referred to as warps. Each thread in a warp or wavefront executes the same instruction at the same time but on different data, a concept known as Single Instruction, Multiple Data. In other words, the GPU is a parallel computing hardware configured for executing multiple parallel computing threads. For instance, it is possible that multiple parallel computing threads are instantiated and assigned with processing tasks associated with different images of different FOVs (more generally, calculations can be assigned to threads and CUs depending on the spatial and/or temporal neighborhood criteria). This would enable calculating, in parallel, image registration parameters for multiple images (cf. box 8015). It would also be possible to cluster such threads in a CU that involve exchange of data; for instance, if per-FOV distributions (along the images of a given sequence) are considered, then all threads associated with calculations for images of that sequence can be assigned to a given CU. For instance, if distributions across image registration parameter values across multiple FOVs in a certain spatial neighborhood are calculated, then all respective calculations can be assigned to a single thread. Then, respective image registration parameter values can be stored in per-CU shared memory. In detail, GPUs implement a hierarchical memory design, including local (per-core), shared (per-CU), and global memory. It would be possible that image registration parameter values are stored in the global memory so as to be accessible by other threads associated with other images or FOVs. On the other hand, variables used for the calculation of the image registration parameter values can be retained in the shared memory, because they are not shared amongst images or FOVs.

In general, it would be possible to allocate memory to the multiple parallel computing threads in accordance with a spatial neighborhood relationship of the FOVs and/or in accordance with a temporal neighborhood relationship between images along the respective sequences.

Using such techniques of parallel processing, memory allocation, and/or data files mimicking the FOV spatial pattern or more generally spatial neighborhood relationships in between FOVs and/or temporal neighborhood relationships between images along the respective image acquisition sequences, enables real time or close-to-real time processing of techniques as previously discussed in connection with FIG. 7. For example, close-to-real time image processing and stitching of large image stacks (e.g. 100 images per series for 91 FOV=9100 images acquired) is not trivial due to the amount of data which is to be processed very quickly. Overall data acquisition must not be hampered by data processing time for allowing direct feedback to the image acquisition workflow and the MSEM. Limiting factors in reference implementations are, e.g., image data transfer time between storage and compute nodes, computing memory consumption, network overhead and power consumption of used computing resources. These drawbacks of the reference implementations are mitigated by the techniques disclosed herein.

Summarizing, techniques have been disclosed above that enable robust frame registration based on neighborhood statistics of multiple individual FOVs associated with different particle beams of a multi-beam particle raster scanning microscope. Outlier images having a particularly poor image quality can be removed prior to executing the image registration, thereby achieving a more robust image registration. The overall image resolution and quality can be improved.

Techniques have been disclosed that enable reliable frame averaging. This enables low-dose imaging with less energy being deposited into the sample based on a reduced dwell time per pixel. As a result, the charge buildup is reduced, such as for samples with low electrical conductivity. Due to the reduced charge buildup, the overall image resolution and quality can be increased. The versatility of imaging using a multi-beam particle raster scanning microscope is increased, for example helping to enable imaging of a wider range of samples also including biological tissue, etc.

The disclosed super-resolution reconstruction enables reducing the physical resolution, i.e., the pixel pitch can be increased. Thereby, the data acquisition can be further accelerated. The charge buildup can be further reduced. Larger areas can be imaged. Super-resolution reconstruction may be generally employed within each FOV (cf. box 8025) and/or with respect to overlap regions of adjacent FOVs (cf. box 8030).

Summarizing, at least the following CLAUSES have been disclosed.

CLAUSE 1. A method for use in a processing device (800, 6000) associated with a multi-beam particle raster scanning microscope (1), each of multiple particle beams (3.1, 3.2, 3.3, 9.1, 9.2, 9.3) of the multi-beam particle raster scanning microscope (1) defining a field of view (1010, 1011, 1012, 1013, 1014, 1015, 1016, 1017, 1018, 1019), the multiple fields of view (1010, 1011, 1012, 1013, 1014, 1015, 1016, 1017, 1018, 1019) of the multiple particle beams (3.1, 3.2, 3.3, 9.1, 9.2, 9.3) being arranged in a spatial pattern (1000) to thereby define an composite field of view (1020),
wherein the method comprises:
   controlling (8005) the multi-beam particle raster scanning microscope (1) to contemporaneously acquire sequences (1050) of respective images (1051, 1052, 1053, 1054) for each field of view (1010, 1011, 1012, 1013, 1014, 1015, 1016, 1017, 1018, 1019),
   for at least some of the images (1051, 1052, 1053, 1054): determining (8015) respective image registration parameter values (7101) based on a comparison with one or more further images of the same field of view (, 1011, 1012, 1013, 1014, 1015, 1016, 1017, 1018, 1019),
   adjusting (8020) one or more of the image registration parameter values (7101) based on a comparison of the image registration parameter values (7101), and
   for each of the multiple fields of view (1010, 1011, 1012, 1013, 1014, 1015, 1016, 1017, 1018, 1019): based on the respective image registration parameter values (7101), aggregating (8025) the respective images (1051, 1052, 1053, 1054) of the respective sequence (1050), to obtain a respective aggregate image (1059), and
   stitching (8035) the aggregate images (1059) obtained for each of the multiple fields of view (1010, 1011, 1012, 1013, 1014, 1015, 1016, 1017, 1018, 1019) in accordance with the spatial pattern (1000), to thereby obtain a composite image for the composite field of view (1020).

CLAUSE 2. The method of CLAUSE 1,
wherein the comparison of the image registration parameter values (7101) takes into account at least one of a spatial neighborhood relationship between the respective fields of view (1010, 1011, 1012, 1013, 1014, 1015, 1016, 1017, 1018, 1019) as defined by the spatial pattern (1000), or a temporal neighborhood relationship between the images (1051, 1052, 1053, 1054) along the sequences (1050).

CLAUSE 3. The method of CLAUSE 1 or 2,
wherein the comparison of the image registration parameter values is based on a distribution (7100) of the image registration parameter values (7101).

CLAUSE 4. The method of CLAUSE 3,
wherein the distribution (7100) is across the image registration parameter values of a subset of all images.

CLAUSE 5. The method of CLAUSE 4,
wherein the subset of all images is selected based on a spatial neighborhood relationship between the respective fields of view (1010, 1011, 1012, 1013, 1014, 1015, 1016, 1017, 1018, 1019) as defined by the spatial pattern (1000).

CLAUSE 6. The method of CLAUSE 4 or 5,
wherein the subset of all images is selected based on a temporal neighborhood relationship between the images (1051, 1052, 1053, 1054) along the sequences (1050).

CLAUSE 7. The method of any one of the preceding CLAUSES, further comprising:
for each of the multiple fields of view: applying (8010) a filter for discarding images in accordance with one or more image quality metrics.

CLAUSE 8. The method of CLAUSE 7,
wherein the one or more image quality metrics take into account a temporal neighborhood relationship between the images (1051, 1052, 1053, 1054) along the sequences (1050).

CLAUSE 9. The method of CLAUSE 7 or 8,
wherein the filter discards images in regimes (7011, 7015) of the sequence (1050) at a beginning or and end of the respective sequence (1050).

CLAUSE 10. The method of any one of CLAUSES 7 to 9,
wherein the image quality metrics are selected from the group comprising: peak signal to noise, PSNR; structural similarity index, SSIM; Fourier ring correlation, FRC; or spectra signal to noise ratio, SSNR.

CLAUSE 11. The method of any one of the preceding CLAUSES,
wherein the adjusting of the image registration parameter values (7101) associated with a given one of the multiple images (1051, 1052, 1053, 1054) is based on further image registration parameters values associated with one or more further ones of the multiple images (1051, 1052, 1053, 1054).

CLAUSE 12. The method of CLAUSE 11,
wherein the one or more further ones of the multiple images (1051, 1052, 1053, 1054) are selected in accordance with at least one of a spatial neighborhood relationship between the respective fields of view (1010, 1011, 1012, 1013, 1014, 1015, 1016, 1017, 1018, 1019) as defined by the spatial pattern (1000), or a temporal neighborhood relationship between the images (1051, 1052, 1053, 1054) along the sequences (1050).

CLAUSE 13. The method of any one of the preceding CLAUSES,
wherein the aggregating (8025) of the respective images (1051, 1052, 1053, 1054) is based on a super-resolution algorithm.

CLAUSE 14. The method of any one of the preceding CLAUSES,
wherein the multiple fields of view (1010, 1011, 1012, 1013, 1014, 1015, 1016, 1017, 1018, 1019) comprise overlap regions in which two or more of the multiple fields of view (1010, 1011, 1012, 1013, 1014, 1015, 1016, 1017, 1018, 1019) overlap,
wherein the method further comprises:
   for each of the overlap regions: applying a super-resolution reconstruction based on the respective two or more of the fields of view (1010, 1011, 1012, 1013, 1014, 1015, 1016, 1017, 1018, 1019) that overlap in the respective overlap region.

CLAUSE 15. The method of any one of the preceding CLAUSES,
wherein the processing device (800, 6000) comprises multiple compute units (6011, 6012, 6013, 6014, 6015, 6016, 6017, 6018, 6019), interconnections between the multiple compute units defining a network topology,
wherein the network topology is configured in accordance with the spatial pattern (1000).

CLAUSE 16. The method of any one of the preceding CLAUSES,
wherein the processing device (800, 6000) comprises multiple compute units (6011, 6012, 6013, 6014, 6015, 6016, 6017, 6018, 6019) configured for executing multiple parallel computing threads,
wherein the method further comprises:
   instantiating multiple parallel computing threads and assigning processing tasks associated with different ones of the fields of view (1010, 1011, 1012, 1013, 1014, 1015, 1016, 1017, 1018, 1019) to different ones of the multiple parallel computing threads.

CLAUSE 17. The method of CLAUSE 16, further comprising:
allocating memory of the processing device (800, 6000) to the multiple parallel computing threads in accordance with at least one of a spatial neighborhood relationship between the respective fields of view as defined by the spatial pattern (1000) or a temporal neighborhood relationship between the images along the sequences.

CLAUSE 18. The method of any one of the preceding CLAUSES, further comprising:
storing data associated with processing tasks associated with the multiple fields of view in a file, a file format of the file being defined in accordance with at least one of a spatial neighborhood relationship between the respective fields of view as defined by the spatial pattern (1000), or a temporal neighborhood relationship between the images along the sequences.

CLAUSE 19. The method of any one of the preceding CLAUSES,
wherein the determining (8015) of the respective image registration parameter values (7101) for the at least some of the images (1051, 1052, 1053, 1054), the adjusting (8020) of the image registration parameter values (7101), and the aggregating (8025) of the respective images (1051, 1052, 1053, 1054) for each of the multiple fields of view (1010, 1011, 1012, 1013, 1014, 1015, 1016, 1017, 1018, 1019) is executed in an iterative process (8027).

CLAUSE 20. The method of any one of the preceding CLAUSES, further comprising:
while the sequences (1050) are being acquired: determining image quality values for the respective images (1051, 1052, 1053, 1054) and adjusting one or more imaging parameters used for the acquiring based on the image quality values.

CLAUSE 21. A processing device for communication with a multi-beam particle raster scanning microscope (1), each of multiple particle beams (3.1, 3.2, 3.3, 9.1, 9.2, 9.3) of the multi-beam particle raster scanning microscope (1) defining a field of view (1010, 1011, 1012, 1013, 1014, 1015, 1016, 1017, 1018, 1019), the multiple fields of view (1010, 1011, 1012, 1013, 1014, 1015, 1016, 1017, 1018, 1019) of the multiple particle beams (3.1, 3.2, 3.3, 9.1, 9.2, 9.3) being arranged in a spatial pattern (1000) to thereby define an composite field of view (1020), the processing device being configured to:
control (8005) the multi-beam particle raster scanning microscope (1) to contemporaneously acquire sequences (1050) of respective images (1051, 1052, 1053, 1054) for each field of view (1010, 1011, 1012, 1013, 1014, 1015, 1016, 1017, 1018, 1019),
for at least some of the images (1051, 1052, 1053, 1054): determine (8015) respective image registration parameter values (7101) based on a comparison with one or more further images of the same field of view (, 1011, 1012, 1013, 1014, 1015, 1016, 1017, 1018, 1019),
adjust (8020) one or more of the image registration parameter values (7101) based on a comparison of the image registration parameter values (7101), and
for each of the multiple fields of view (1010, 1011, 1012, 1013, 1014, 1015, 1016, 1017, 1018, 1019): based on the respective image registration parameter values (7101), aggregate (8025) the respective images (1051, 1052, 1053, 1054) of the respective sequence (1050), to obtain a respective aggregate image (1059), and
stitch (8035) the aggregate images (1059) obtained for each of the multiple fields of view (1010, 1011, 1012, 1013, 1014, 1015, 1016, 1017, 1018, 1019) in accordance with the spatial pattern (1000), to thereby obtain a composite image for the composite field of view (1020).

CLAUSE 22. The processing device, wherein the processing device is configured to perform the method of any one of CLAUSES 1 to 20.

CLAUSE 23. A system, comprising:
the processing device of CLAUSE 21 or 22, and
the multi-beam particle raster scanning microscope (1).

Although the disclosure has been shown and described with respect to certain embodiments, equivalents and modifications will occur to others skilled in the art upon the reading and understanding of the specification. The present disclosure includes all such equivalents and modifications and is limited only by the scope of the appended claims.

For instance, while various examples have been disclosed for MSEMs, similar techniques can be employed for other types of multi-beam particle raster scanning microscopes.

For instance, above various examples have been disclosed pertaining to calculation of an image quality value for discarding images in a respective filter procedure, cf. FIG. 7: box 8010. Various image quality metrics used for calculating such image quality value have been discussed, including the FRC. It would also be possible to use calculation of the FRC image quality value in other contexts, e.g., as a standalone benchmark for the image quality of images acquired using charged particle raster scanning microscopes. The calculation of the FRC image quality value does not need to be embedded into the process discussed in FIG. 7, but can also be used in isolation.

1. A method of using a processing device configured to control a multi-beam particle raster scanning microscope configured to generate multiple particle beams configured to impinge on a sample, each of the multiple particle beams of the multi-beam particle raster scanning microscope defining a field of view at the sample thereby generating multiple fields of view at the sample, the multiple fields of view at the sample being arranged in a spatial pattern to define a composite field of view, the method comprising:
controlling the multi-beam particle raster scanning microscope with the processing device to contemporaneously acquire sequences of respective images of the sample for each field of view;
for at least some of the images, determining respective image registration parameter values based on a comparison with one or more further images of the same field of view;
adjusting one or more of the image registration parameter values based on a comparison of the image registration parameter values;
for each of the multiple fields of view at the sample, based on the respective image registration parameter values, aggregating the respective images of the respective sequence to obtain a respective aggregate image; and
stitching the aggregate images obtained for each of the multiple fields of view in accordance with the spatial pattern to obtain a composite image for the composite field of view.

2. The method of claim 1, wherein comparing the image registration parameter values takes into account at least one member selected from the group consisting of a spatial neighborhood relationship between the respective fields of view as defined by the spatial pattern, and a temporal neighborhood relationship between the images along the sequences.

3. The method of claim 1, wherein comparing the image registration parameter values is based on a distribution of the image registration parameter values.

4. The method of claim 3, wherein the distribution of the image registration parameter values is across the image registration parameter values of a subset of all images.

5. The method of claim 4, wherein the subset of all images is selected based on a spatial neighborhood relationship between the respective fields of view as defined by the spatial pattern.

6. (canceled)

7. The method of claim 1, further comprising, for each of the multiple fields of view, applying a filter for discarding images in accordance with one or more image quality metrics.

8. The method of claim 7, wherein the one or more image quality metrics takes into account a temporal neighborhood relationship between the images along the sequences.

9. The method of claim 7, wherein the filter discards images in regimes of the sequence at a beginning or an end of the respective sequence.

10. The method of claim 7, wherein the image quality metrics are selected from the group consisting of a peak signal to noise, a structural similarity index, a Fourier ring correlation, and a spectra signal to noise ratio.

11. The method of claim 1, wherein adjusting the image registration parameter values associated with a given one of the multiple images is based on further image registration parameters values associated with one or more further images of the multiple images.

12. (canceled)

13. The method of claim 1, wherein aggregating the respective images is based on a super-resolution algorithm.

14. The method of claim 1, wherein:
the multiple fields of view comprise overlap regions in which two or more of the multiple fields of view overlap; and
the method further comprises, for each overlap region, applying a super-resolution reconstruction based on the respective two or more of the fields of view that overlap in the respective overlap region.

15. The method of claim 1, wherein the processing device comprises multiple compute units, interconnections between the multiple compute units define a network topology, and the network topology is configured in accordance with the spatial pattern.

16. The method of claim 1, wherein:
the processing device comprises multiple compute units configured to execute multiple parallel computing threads; and
the method further comprises instantiating multiple parallel computing threads and assigning processing tasks associated with different ones of the fields of view to different ones of the multiple parallel computing threads.

17. (canceled)

18. The method of claim 1, further comprising storing data associated with processing tasks associated with the multiple fields of view in a file, wherein a file format of the file is defined in accordance with at least one member selected from the group consisting of a spatial neighborhood relationship between the respective fields of view as defined by the spatial pattern, and a temporal neighborhood relationship between the images along the sequences.

19. The method of claim 1, comprising executing in an iterative process: i) determining the respective image registration parameter values for the at least some of the images; ii) adjusting the image registration parameter values, and iii) aggregating the respective images for each of the multiple fields of view.

20. The method of claim 1, further comprising, acquiring the sequences, determining image quality values for the respective images and adjusting one or more imaging parameters used for the acquiring based on the image quality values.

21. One or more machine-readable hardware storage devices comprising instructions that are executable by one or more processing devices to perform the method of claim 1.

22. A system, comprising:
one or more processing devices; and
one or more machine-readable hardware storage devices comprising instructions that are executable by one or more processing devices to perform the method of claim 1.

23. The system of claim 22, further comprising a multi-beam particle raster scanning microscope.
